(19) United States
(12) Patent Application Publication
(10) Pub. No.: US 2019/0344592 A1
(43) Pub. Date: Nov. 14, 2019

(54) IMAGE FORMING APPARATUS

(71) Applicant: Konica Minolta, Inc., Tokyo (JP)

(72) Inventors: Tomoyoshi Yukimoto, Nagoya-shi (JP); Masahiro Yamaguchi, Toyokawa-shi (JP); Seiji Shibata, Toyokawa-shi (JP); Shoichi Yoshikawa, Tokyo (JP)

(21) Appl. No.: 16/384,429

(22) Filed: Apr. 15, 2019

(30) Foreign Application Priority Data
May 14, 2018 (JP) 2018-092800

(51) Int. Cl. B41J 13/00; B41J 11/00

(52) U.S. Cl. CPC B41J 13/0009; B41J 11/002; B41J 11/0085

(57) ABSTRACT

An image forming apparatus includes: a conveyor including a conveyance belt that conveys a recording medium along a conveyance direction; at least one or more heads that discharge ink to the conveyed recording medium; and a suction part that causes the recording medium to be adsorbed to the conveyance belt, wherein the conveyor is provided with: a first suction region including at least a region where the head discharges ink in accordance with an image forming region of the recording medium; and a second suction region located in a periphery of the first suction region, and suction force by the suction part is larger in the first suction region than in the second suction region.

The entire disclosure of Japanese patent Application No. 2018-092800, filed on May 14, 2018, is incorporated herein by reference in its entirety.

### BACKGROUND

### Technological Field

The present disclosure relates to an image forming apparatus including a head that discharges ink.

### Description of the Related Art

In recent years, an industrial inkjet recording apparatus is developed as an image forming apparatus capable of printing a printed matter for a commercial purpose. In such an industrial inkjet recording apparatus, image quality higher than image quality in an inkjet recording apparatus for ordinary consumers is required.

In the field of package print products, there may be a case where an image is formed on thick paper (e.g., flute paper, cardboard, or the like) having a thickness of about 0.3 mm to 1.5 mm, for example. In this case also, higher image quality is required.

To form a high-quality image on such thick paper, it is necessary to convey a sheet in a horizontal state and keep a constant distance between the sheet and a head that discharges ink to the sheet. An appropriate amount of the ink can be made to adhere to a desired place by keeping the constant distance between the sheet and the head.

Generally, a sheet is conveyed by a conveyance belt. Flatness of the sheet conveyed by the conveyance belt (more specifically, the distance between the sheet and the head) is influenced by flatness of the conveyance belt, flatness of a support member supporting the conveyance belt, and adsorbability between the sheet and the conveyance belt.

Among these, the adsorbability is secured by: generating negative pressure on the conveyance belt having a plurality of holes and the belt support member having a plurality of suction holes; and making a space between the conveyance belt and the sheet close to a vacuum state.

Exemplary literature in which an inkjet recording apparatus having the above-described conveyance mechanism can include JP 2016-150794 A, WO 2013/150677 A1, JP 2016-107435 A, and the like.

In the inkjet recording apparatus disclosed in JP 2016-150794 A, a suction chamber (belt support member) provided with a plurality of rollers is arranged between a pair of winding rollers around which a conveyance belt is wound.

In the inkjet recording apparatus disclosed in WO 2013/150677 A1, provided is a holding mechanism that holds a conveyance belt in a state not contacting the conveyance belt. The holding mechanism includes a gas suction part to which a gas is sucked and a gas supply part to which gas is supplied, and partly applies positive pressure while applying negative pressure to the conveyance belt.

In the inkjet recording apparatus disclosed in JP 2016-107435 A, a conveyance belt is provided slidably on a support member, and the support member that supports the conveyance belt includes: a first region located more on an upstream side in a conveyance direction than a facing region facing a head; and a second region located on a downstream side of the first region in the conveyance direction and including the facing region. Negative pressure applied to the first region is larger than negative pressure applied to the second region.

Here, in a case of making a space between a conveyance belt and a sheet to a vacuum state in an entire region of a passing region through which the sheet passes above a support member, frictional force acting between the conveyance belt and the support member is increased. In this case, a wear amount of the conveyance belt is increased, and therefore, life of the conveyance belt is shortened. Additionally, a drive load of the conveyance belt is also increased.

In an inkjet recording apparatus disclosed in JP 2016-150794 A, since a conveyance belt is made to travel by a plurality of rollers, friction acting between a conveyance belt and a belt support member can be reduced. However, since the plurality of rollers is used, an assembling property is no good and it is difficult to secure flatness of the belt. As a result, it is also difficult to secure flatness of a sheet.

In an inkjet recording apparatus disclosed in W02013/150677 A1, frictional force does not act between a conveyance belt and a holding mechanism. However, in a region where no negative pressure is applied (that is, a region where positive pressure is applied), adsorbability between a sheet and the conveyance belt is decreased, and therefore, it is difficult to secure flatness of the sheet.

In an inkjet recording apparatus disclosed in JP 2016-107435 A, suction force is increased in a region where a support member does not face a head, and suction force is weakened in a region where the support member faces the head. Due to this, it is difficult to secure flatness of a sheet in a region where ink is discharged to the sheet.

### SUMMARY

The present disclosure is made in view of the above-described problems, and the present disclosure is directed to providing an image forming apparatus in which flatness of a recording medium can be secured while friction acting on a conveyance belt that conveys the recording medium is reduced.

To achieve the abovementioned object, according to an aspect of the present invention, an image forming apparatus reflecting one aspect of the present invention comprises: a conveyor including a conveyance belt that conveys a recording medium along a conveyance direction; at least one or more heads that discharge ink to the conveyed recording medium; and a suction part that causes the recording medium to be adsorbed to the conveyance belt, wherein the conveyor is provided with: a first suction region including at least a region where the head discharges ink in accordance with an image forming region of the recording medium; and a second suction region located in a periphery of the first suction region, and suction force by the suction part is larger in the first suction region than in the second suction region.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram of an inkjet recording apparatus according to a first embodiment;

FIG. 2 is a schematic diagram illustrating a configuration of an image former included in the inkjet recording apparatus according to the first embodiment;

FIG. 3 is a schematic diagram illustrating a peripheral structure of a head included in the image former according to the first embodiment;

FIG. 4 is a schematic plan view illustrating a first conveyance mode in the image former according to the first embodiment;

FIG. 5 is a schematic plan view illustrating a second conveyance mode in the image former according to the first embodiment;

FIG. 6 is a schematic plan view illustrating a third conveyance mode in the image former according to the first embodiment;

FIG. 7 is a schematic diagram illustrating a peripheral structure of a head included in an inkjet recording apparatus according to a second embodiment;

FIG. 8 is a schematic diagram illustrating a peripheral structure of a head included in an inkjet recording apparatus according to a third embodiment; and

FIG. 9 is a front view from a direction of an arrow illustrated in FIG. 8.

### DETAILED DESCRIPTION OF EMBODIMENTS

Hereinafter, one or more embodiments of the present invention will be described with reference to the drawings. However, the scope of the invention is not limited to the disclosed embodiments. In the embodiments described below, an inkjet recording apparatus will be described as an example of an image forming apparatus. Note that, in the following embodiments, identical or common members will be denoted by the same reference signs in the drawings, and descriptions thereof will not be repeated.

### First Embodiment

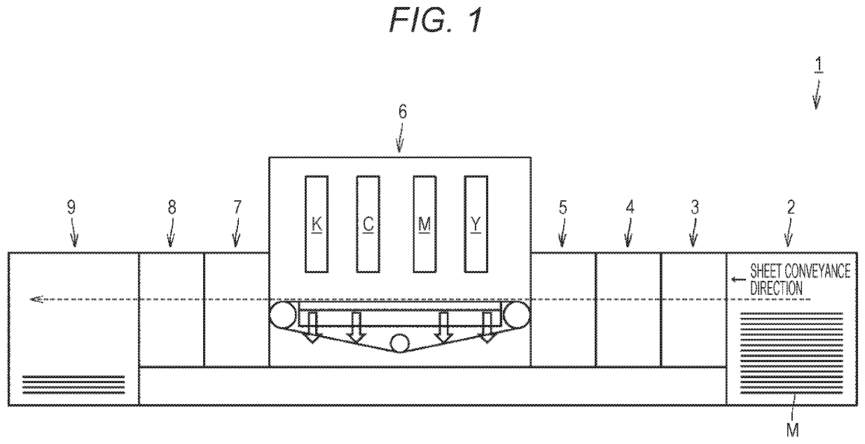

FIG. 1 is a schematic diagram of an inkjet recording apparatus according to a first embodiment. An inkjet recording apparatus 1 according to the first embodiment will be described with reference to FIG. 1.

As illustrated in FIG. 1, the inkjet recording apparatus 1 according to the first embodiment includes a plurality of processors, and a recording medium is sequentially conveyed to the plurality of processors. The plurality of processors includes a sheet feeder 2, an electric discharger 3, a heater 4, a registration part 5, an image former 6, an irradiator 7, an inspecting part 8, and a stacker 9.

The sheet feeder 2, the electric discharger 3, the heater 4, the registration part 5, the image former 6, the irradiator 7, the inspecting part 8, and the stacker 9 are arranged in this order along a conveyance direction of a recording medium M.

The sheet feeder 2 supplies the recording medium M to the electric discharger 3 located on a downstream side in the conveyance direction. The sheet feeder 2 houses a plurality of recording media M. As the recording media M, it is possible to use flat paper, thick paper, a cardboard material, a resin plate, and the like.

The electric discharger 3 discharges electricity toward the recording medium M. The electric discharger 3 reforms a property of a surface of the recording medium M by irradiating the recording medium M with plasma or the like, for example. Consequently, affinity between the recording medium M and ink is enhanced. The electric discharger 3 conveys, to the heater 4, the recording medium M that has been subjected to the reform of the surface property.

The heater 4 heats the recording medium M such that the recording medium M comes to have a temperature within a desired temperature range. The heater 4 conveys the heated recording medium M to the registration part 5. The registration part 5 corrects a posture of the recording medium M skewing with respect to the conveyance direction. The registration part 5 conveys, to the image former 6, the recording medium M having the posture corrected.

The image former 6 forms an image on the surface of the conveyed recording medium M. In the image former 6, the ink is discharged to the surface of the recording medium M. The image former 6 conveys, to the irradiator 7, the recording medium M having the image formed thereon.

The irradiator 7 irradiates the recording medium M with light such as UV to cure the ink discharged to the recording medium M. Consequently, the image is fixed on the recording medium M. The irradiator 7 conveys, to the inspecting part 8, the recording medium M having the image fixed.

The inspecting part 8 inspects the image fixed on the recording medium M by using a line sensor or the like. The inspecting part 8 ejects the inspected recording medium M to the stacker 9. The stacker 9 houses the recording medium M having the image fixed.

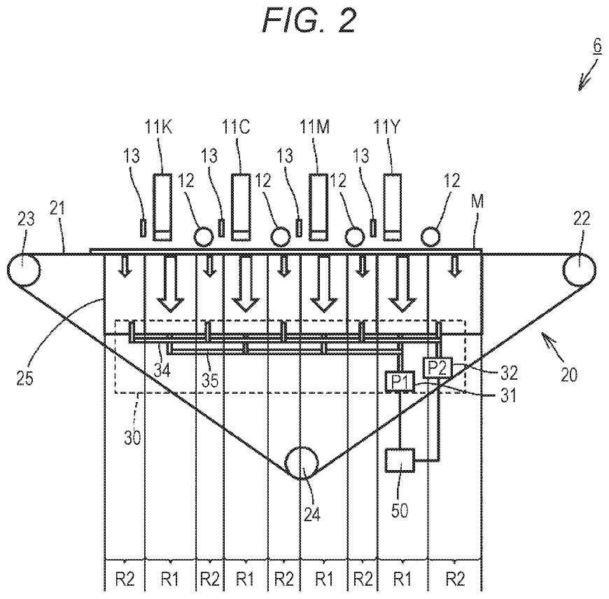

FIG. 2 is a schematic diagram illustrating a configuration of the image former included in the inkjet recording apparatus according to the first embodiment. The image former 6 will be described with reference to FIG. 2.

As illustrated in FIG. 2, the image former 6 includes a plurality of heads 11Y, 11M, 11C, and 11K, a conveyor 20, a suction part 30, and controller 50.

The plurality of heads 11Y, 11M, 11C, and 11K is arranged in this order along the conveyance direction of the recording medium M. The plurality of heads 11Y, 11M, 11C, and 11K is arranged along a conveyance belt 21 described later.

The plurality of heads 11Y, 11M, 11C, and 11K discharges ink to the conveyed recording medium M. The head 11Y discharges yellow ink. The head 11M discharges magenta ink. The head 11C discharges cyan ink. The head 11K discharges black ink. The ink of each color includes a photocurable material.

The image former 6 further includes a plurality of roller members 12 and a plurality of light irradiators 13. Each of the plurality of roller members 12 is arranged on the upstream side in the conveyance direction of each of the heads 11Y, 11M, 11C, and 11K.

Each roller member 12 is biased toward the conveyor 20 side and functions as a pressing member. The roller member 12 presses a conveyed recording medium M against the conveyance belt 21.

Each of the plurality of light irradiators 13 is arranged on the downstream side in the conveyance direction of each of the heads 11Y, 11M, 11C, and 11K. Each light irradiator 13 arranged on the downstream side in the conveyance direction of each head semi-cures the ink discharged from each head.

The conveyor 20 conveys the recording medium along the conveyance direction. The conveyor 20 includes the conveyance belt 21, a drive roller 22, a driven roller 23, a tension roller 24, and a support member 25.

The conveyance belt 21 is an endless belt. The conveyance belt 21 is wound around the drive roller 22, the driven roller 23, and the tension roller 24. With rotation of the drive roller 22, the conveyance belt 21 is rotated to convey the recording medium M.

The conveyance belt 21 is provided with a plurality of suction holes. The recording medium M can be adsorbed to the conveyance belt 21 by the air being sucked through the suction holes.

The drive roller 22 and the driven roller 23 are arranged apart from each other in the conveyance direction. The drive roller 22 is rotationally driven by a motor (not illustrated), for example. The conveyance belt 21 and the driven roller 23 are rotated in conjunction with rotation of the drive roller 22.

The tension roller 24 is arranged below the support member 25. The tension roller 24 is provided movably in a vertical direction. Tension is appropriately applied to the conveyance belt 21 by setting a vertical position of the tension roller 24.

The support member 25 is arranged in a manner facing the plurality of heads 11Y, 11M, 11C, and 11K. The support member 25 is arranged in an interspace between the drive roller 22 and the driven roller 23.

The support member 25 supports the conveyance belt 21 such that the conveyance belt 21 passes through the space with each of the heads 11Y, 11M, 11C, and 11K. The support member 25 has a support surface that supports the conveyance belt 21. The support surface abuts on an inner peripheral surface of the conveyance belt 21.

The support member 25 is provided with a plurality of through holes. The plurality of through holes is provided in a manner penetrating the support surface. The plurality of through holes communicates with the plurality of suction holes provided in a part of the conveyance belt 21 abutting on the support member 25. In the support member 25, a region where the plurality of through holes is provided is partitioned into a plurality of partition regions. The plurality of partition regions is arranged in a lattice shape, for example.

The suction part 30 causes the recording medium M to be adsorbed to the conveyor 20. Specifically, the suction part 30 causes the recording medium M to be adsorbed to the conveyance belt 21 by sucking the air from the suction holes and the through holes. The suction part 30 can suck the air through the suction holes and the through holes in each of the partition regions.

The suction part 30 includes a first pump 31, a second pump 32, a first pipe 34, and a second pipe 35. The first pipe 34 has one end side connected to the first pump 31. The first pipe 34 has the other end side branched, and the branched ends are connected to some partition regions out of the plurality of partition regions. The second pipe 35 has one end side connected to the second pump 32. The second pipe 35 has the other end side branched, and the branched ends are connected remaining partition regions out of the plurality of partition regions.

Note that the suction part 30 includes a plurality of solenoid valves. The solenoid valves are respectively provided on the end sides of the first pipe 34 and the second pipe 35 which are branched and connected to the respective partition regions.

The controller 50 controls suction operation of the suction part 30. Specifically, the controller 50 controls suction force in each partition region by appropriately controlling suction force of each of the first pump 31 and the second pump 32 and/or an opening and closing degree of each of the solenoid valves. Consequently, the controller 50 forms, in the conveyor 20, a first suction region R1 and a second suction region R2 having different levels of the suction force. The suction force in the first suction region R1 is larger than the suction force in the second suction region R2.

The controller 50 can change a size of the first suction region R1 and a size of the second suction region R2 by controlling the suction operation of the suction part 30 as described above in accordance with a size of an image forming region of the recording medium M.

Note that the number of pumps and the number of pipes are not limited to two and can be appropriately changed.

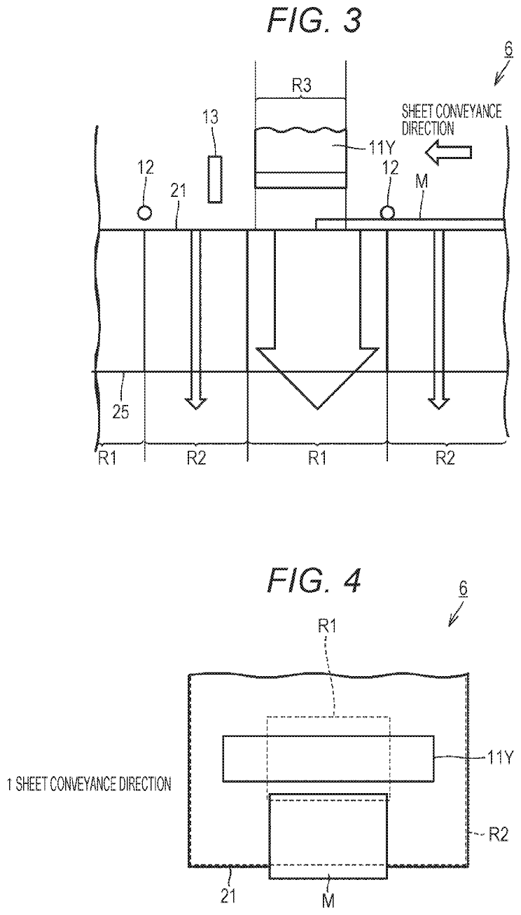

FIG. 3 is a schematic diagram illustrating a peripheral structure of a head included in the image former according to the first embodiment. Note that FIG. 3 illustrates, for convenience, a peripheral structure of one head 11Y out of the plurality of heads included in the image former.

As illustrated in FIG. 3, the roller member 12 is arranged in a boundary between the first suction region R1 and the second suction region R2. Note that the first suction region R1 is a region including at least a region R3 in which ink is discharged in accordance with an image forming region of the recording medium on which an image is to be formed. The second suction region R2 is located in the periphery of the first suction region R1.

Since the roller member 12 is arranged as described above, the recording medium M is conveyed to the first suction region R1 in a state in which the recording medium is pressed against the conveyance belt 21 by the roller member 12.

Consequently, floating of a leading edge of the recording medium M on the downstream side in the conveyance direction can be suppressed, and the recording medium M can be surely adsorbed to the conveyance belt 21 in the first suction region R1.

Additionally, it is preferable that a conveyance speed at which the roller member 12 conveys the recording medium in the conveyance direction be equal to or faster than a conveyance speed at which the conveyor 20 conveys the recording medium M. Consequently, tension can be generated at the recording medium M while the recording medium M is surely guided in the conveyance direction. Therefore, deflection of the recording medium M can be prevented.

Additionally, the light irradiator 13 and the roller member 12 are arranged on the downstream side in the conveyance direction of the head 11Y. The roller member 12 located on the downstream side in the conveyance direction of the head 11Y is arranged between the head 11Y and the head 11M.

Also, the light irradiator 13 is arranged between the head 11Y and the roller member 12 located on the downstream side in the conveyance direction of the head 11Y. The light irradiator 13 semi-cures the ink by irradiating, with light such as ultraviolet, the ink discharged from the head 11Y.

Since the ink is semi-cured, it is possible to suppress the ink from adhering to the roller member 12 when the roller member 12 located on the downstream side in the conveyance direction of the head 11Y abuts on the recording medium M that passes through the head 11Y and is moved toward the next head 11M.

FIGS. 4 to 6 are schematic plan views illustrating first to third conveyance modes in the image former according to the first embodiment. The conveyance modes in the image former 6 will be described with reference to FIGS. 4 to 6. Note that, in FIG. 4 to FIG. 6, illustration of the roller member 12, the light irradiator 13, and the like are omitted for convenience.

As illustrated in FIG. 4, a recording medium M having a small size is conveyed in the first conveyance mode. In this case, a width of the first suction region R1 orthogonal to the conveyance direction is small.

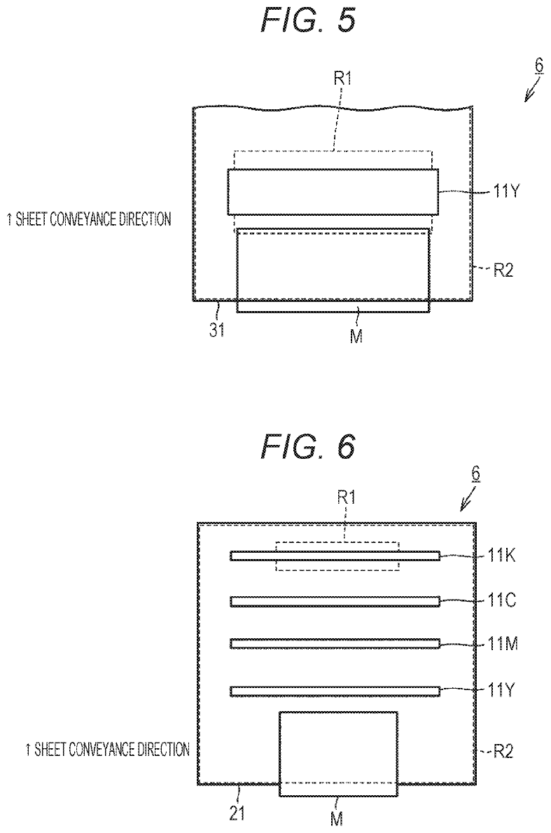

As illustrated in FIG. 5, a recording medium M having a large size is conveyed in the second conveyance mode. In this case, the width of the first suction region R1 is increased.

As illustrated in FIG. 6, the third conveyance mode is a conveyance mode in a case where image forming mode is monochrome printing. In this case, only a periphery of a region where the head 11K used for the monochrome printing discharges the ink is set as the first suction region R1.

As illustrated in FIGS. 4 to 6, the controller 50 can appropriately change a size of the first suction region R1 by controlling suction operation of the suction part 30 in accordance with an image forming region and/or an image forming mode.

As described above, in the inkjet recording apparatus 1 according to the first embodiment, the conveyor 20 is provided with: the first suction region R1 including at least the region R3 where the head discharges the ink in accordance with the image forming region of the recording medium M; and the second suction region R2 located in the periphery of the first suction region R1, and the suction force in the suction part 30 is larger in the first suction region R1 than in the second suction region R2.

Due to this, in the first suction region R1 including the region R3 where the ink is discharged from the head, the recording medium M can be surely sucked to the conveyance belt 21. Consequently, it is possible to secure flatness of the recording medium M when the ink is discharged from the head.

Additionally, in the second suction region R2 located in the periphery of the first suction region R1, the suction force is smaller than that in the first suction region R1. Due to this, it is possible to reduce frictional force generated by the conveyance belt 21 sliding on the support member 25 when the conveyance belt 21 passes through the second suction region R2.

As described above, the inkjet recording apparatus 1 according to the first embodiment provides an image forming apparatus in which the flatness of the recording medium can be secured while friction acting on the conveyance belt that conveys the recording medium M is reduced.

### Second Embodiment

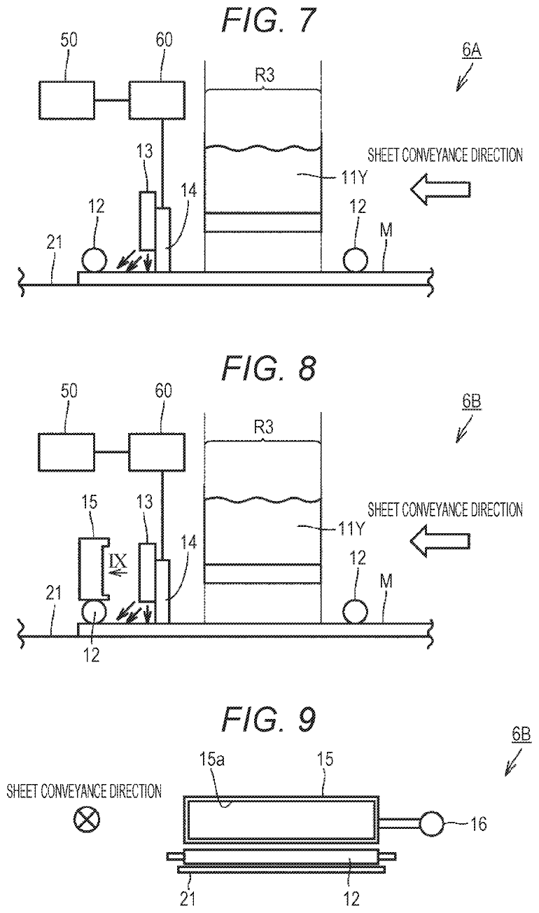

FIG. 7 is a schematic diagram illustrating a peripheral structure of a head included in an inkjet recording apparatus according to a second embodiment. Note that FIG. 7 illustrates, for convenience, the peripheral structure of one head 11Y out of a plurality of heads included in the inkjet recording apparatus. The inkjet recording apparatus according to the second embodiment will be described with reference to FIG. 7.

As illustrated in FIG. 7, the inkjet recording apparatus according to the second embodiment differs from an inkjet recording apparatus 1 according to a first embodiment in a configuration of an image former 6A. Configurations of other parts are substantially similar. The image former 6A mainly differs from an image former 6 according to the first embodiment in including a plurality of partition members 14.

Each of the plurality of partition members 14 is arranged between each of heads 11Y, 11M, 11C, and 11K and each of the light irradiators 13 arranged on a downstream side in a conveyance direction of each of the heads 11Y, 11M, 11C, and 11K. Each partition member 14 shields light directed from the light irradiator to the head located more on an upstream side in the conveyance direction than the light irradiator.

Each partition member 14 is arranged above a conveyance belt 21 such that a recording medium M can pass through an interspace between the partition member 14 and the conveyance belt 21.

The image former 6 further includes a moving device 60 that moves each partition member 14. For example, the moving device 60 moves the partition member 14 in the vertical direction. As the moving device 60, it is possible to adopt a slide device or the like including a guide that guides movement of the partition member 14.

Operation of the moving device 60 is controlled by a controller 50. The controller 50 controls the operation of the moving device 60 to adjust an interval between the partition member 14 and the conveyance belt 21 in accordance with a thickness of the recording medium M.

In the case of having the above-described configuration also, the inkjet recording apparatus according to the second embodiment can obtain effects substantially similar to effects of the inkjet recording apparatus 1 according to the first embodiment.

Furthermore, with the configuration including the partition members 14, light emitted from the light irradiator 13 can be suppressed from directly entering each head. Consequently, ink can be suppressed from being cured at the head.

### Third Embodiment

FIG. 8 is a schematic diagram illustrating a peripheral structure of a head included in an inkjet recording apparatus according to a third embodiment. FIG. 9 is a front view from a direction of an arrow IX illustrated in FIG. 8. The inkjet recording apparatus according to the third embodiment will be described with reference to FIGS. 8 and 9.

As illustrated in FIG. 8, the inkjet recording apparatus according to the third embodiment differs from an inkjet recording apparatus according to a second embodiment in a configuration of an image former 6B.

Configurations of other parts are substantially similar. The image former 6B mainly differs from an image former 6A according to the second embodiment in including a plurality of ducts 15.

Each of the plurality of ducts 15 is provided for each of the heads 11Y, 11M, 11C, and 11K and arranged on a downstream side in a conveyance direction of each of these heads. Specifically, each duct 15 is arranged more on the downstream side in the conveyance direction of each light irradiator 13.

Suspended matters suspended in the head and in the periphery of each light irradiator arranged more on the downstream side in the conveyance direction than each head can be collected. The suspended matters include ink mist generated due to a difference of the ink discharged from the respective heads, ozone generated by each light irradiator, and the like.

As illustrated in FIG. 9, each duct 15 includes a suction port 15a directed to the head 11Y and to the light irradiator 13. The duct 15 is provided with a fan 16, and surrounding air is sucked from the suction port 15a by rotation of the fan 16.

In the case of having the above-described configuration also, the inkjet recording apparatus according to the third embodiment can obtain effects substantially similar to effects of the inkjet recording apparatus according to the second embodiment.

Furthermore, since each duct 15 capable of collecting the suspended matters is provided, deterioration of a roller member 12 caused by ozone and ink contamination caused by the ink mist can be suppressed. Moreover, since each duct 15 is provided on the downstream side in the conveyance direction of each light irradiator 13, the light from the light irradiator 13 is suppressed from directly entering each head located more on the downstream side in the conveyance direction than the light irradiator 13. Consequently, ink can be suppressed from being cured at the head.

Note that, in the first to third embodiments described above, the case where the roller member abutting on a recording medium M is used as the pressing member has been described, but not limited thereto, a blowing device may also be used. In this case, the blowing device presses the recording medium M against the conveyance belt 21 by blowing the air to the recording medium M.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a conveyor including a conveyance belt that conveys a recording medium along a conveyance direction;
at least one or more heads that discharge ink to the conveyed recording medium; and
a suction part that causes the recording medium to be adsorbed to the conveyance belt,
wherein the conveyor is provided with: a first suction region including at least a region where the head discharges ink in accordance with an image forming region of the recording medium; and a second suction region located in a periphery of the first suction region, and
suction force by the suction part is larger in the first suction region than in the second suction region.

2. The image forming apparatus according to claim 1, further comprising
a controller that controls suction operation of the suction part,
wherein the controller changes a size of the first suction region by controlling the suction operation in accordance with a size of the image forming region and/or an image forming mode.

3. The image forming apparatus according to claim 2,
wherein the conveyor includes a support member that is arranged in a manner facing the head, and supports the conveyance belt such that the conveyance belt passes through a space with the head,
the conveyance belt is provided with a plurality of suction holes,
the support member is provided with a plurality of through holes communicating with the plurality of the suction holes provided in a part of the conveyance belt abutting on the support member,
a region included in the support member and provided with the plurality of through holes is partitioned into a plurality of partition regions,
the suction part can suck a gas through the suction holes and the through holes in each of the partition regions, and
the controller controls the suction operation such that suction force in some partition regions corresponding to the first suction region out of the plurality of partition regions becomes larger than suction force in remaining partition regions out of the plurality of partition regions.

4. The image forming apparatus according to claim 1, further comprising
a pressing member that is arranged more on an upstream side in the conveyance direction than the head, and presses the conveyed recording medium against the conveyance belt,
wherein the pressing member is arranged in a boundary between the second suction region and the first suction region in the conveyance direction, and
the recording medium is conveyed to the first suction region in a state in which the recording medium is pressed against the conveyance belt by the pressing member.

5. The image forming apparatus according to claim 4, wherein the pressing member includes a roller member.

6. The image forming apparatus according to claim 5, wherein a conveyance speed at which the roller member conveys the recording medium in the conveyance direction is equal to or faster than a conveyance speed at which the conveyor conveys the recording medium.

7. The image forming apparatus according to claim 4,
wherein the at least one or more heads include a first head, and a second head arranged more on a downstream side in the conveyance direction than the first head,
the pressing member is arranged at least between the first head and the second head, and
the image forming apparatus further comprises a light irradiator that is arranged between the first head and the pressing member in the conveyance direction, and cures ink discharged from the first head to the recording medium.

8. The image forming apparatus according to claim 7, further comprising
a partition member arranged between the first head and the light irradiator,
wherein the partition member shields light emitted from the light irradiator and directed to the first head.

9. The image forming apparatus according to claim 8, further comprising:
a moving device provided to move the partition member; and
a controller that controls operation of the moving device,
wherein the controller controls the operation of the moving device to adjust an interval between the partition member and the conveyance belt in accordance with a thickness of the recording medium.

10. The image forming apparatus according to claim 7, further comprising a duct capable of collecting a suspended matter suspended in a periphery of the light irradiator and the first head.
